(19) United States
(12) Patent Application Publication
(10) Pub. No.: US 2025/0106725 A1
(43) Pub. Date: Mar. 27, 2025

(54) SYSTEM AND METHOD FOR FRAME EXCHANGE CONTEXT UNDER MULTI-LINK DEVICE (MLD) ROAMING

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/821,350

(22) Filed: Aug. 30, 2024

Related U.S. Application Data
(60) Provisional application No. 63/585,910, filed on Sep. 27, 2023.

(51) Int. Cl. H04W 36/32; H04W 4/90; H04W 36/00

(52) U.S. Cl. CPC H04W 36/32; H04W 4/90; H04W 36/0044; H04W 36/0061

(57) ABSTRACT

Embodiments of a method and apparatus for communications are disclosed. In an embodiment, an access point (AP) device includes a controller configured to determine a frame exchange context for frame exchanges with a non-AP device roaming from a current serving AP MLD affiliated with a roaming MLD group identifying address to a new serving AP MLD affiliated with the roaming MLD group identifying address and a wireless transceiver configured to conduct the frame exchanges with the non-AP device based on the frame exchange context.

### CROSS-REFERENCE TO RELATED APPLICATIONS

This application is entitled to the benefit of U.S. Provisional Patent Application Ser. No. 63/585,910, filed on Sep. 27, 2023, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput, for example, during device roaming. To facilitate the proper data transmission during device roaming within a multi-link communications system, there is a need for wireless communications technology that can efficiently and securely convey communications signaling information, for example, information related to data, communications links, and/or multi-link devices (e.g., operation and/or capability parameters of multi-link devices) during device roaming within the multi-link communications system.

### SUMMARY

Embodiments of a method and apparatus for communications are disclosed. In an embodiment, an access point (AP) device includes a controller configured to determine a frame exchange context for frame exchanges with a non-AP device roaming from a current serving AP MLD affiliated with a roaming MLD group identifying address to a new serving AP MLD affiliated with the roaming MLD group identifying address and a wireless transceiver configured to conduct the frame exchanges with the non-AP device based on the frame exchange context. Other embodiments are also disclosed.

In an embodiment, the roaming MLD group identifying address includes a common Media Access Control (MAC) address that is used to identity a group of AP MLDs for association or key negotiation with the non-AP device and to identify the new serving AP MLD to which the non-AP device is roamed to.

In an embodiment, the frame exchange context includes information for downlink (DL) frame transmission from the new serving AP MLD to the non-AP device.

In an embodiment, the information for DL frame transmission includes pairwise transient key (PTK) information and smallest unallocated packet number (PN) information for unicast data frame or management frame transmission.

In an embodiment, the information for DL frame transmission includes a smallest unallocated sequence number (SN) in a SN space for unicast quality of service (QOS) data frames of each traffic identifier (TID) addressed to the non-AP device, BA agreement parameters, and a start of an originator window information of BA agreement when the current serving AP MLD and the new serving AP MLD transmit QoS data frames during a roaming procedure.

In an embodiment, the information for DL frame transmission includes a smallest unallocated sequence number (SN) in a SN space for unicast management frames addressed to the non-AP device.

In an embodiment, the frame exchange context includes information for uplink (UL) frame reception at the new serving AP MLD from the non-AP device.

In an embodiment, the information for UL frame reception includes pairwise transient key (PTK) information and a replay counter of packet number (PN) information for each traffic identifier (TID) of unicast data frame reception or a replay counter of PN information for management frame reception.

In an embodiment, the information for UL frame reception includes BA agreement parameters, a largest sequence number (SN) of a SN space whose related frame is sent to an upper layer for unicast quality of service (QOS) data frames of each traffic identifier (TID) from the non-AP device.

In an embodiment, the information for UL frame reception includes a largest sequence number (SN) of a SN space whose related frame is sent to an upper layer for unicast management frames from the non-AP device.

In an embodiment, the frame exchange context includes information regarding whether the non-AP device's emergency preparedness communications service (EPCS) is enabled.

In an embodiment, the non-AP device includes a non-AP MLD.

In an embodiment, the controller is further configured to determine the frame exchange context for the frame exchanges between the new serving AP MLD and the non-AP device based on a frame exchange context for frame exchanges between the current serving AP MLD and the non-AP device.

In an embodiment, the current serving AP MLD notifies the non-AP device a largest sequence number (SN) of a SN space whose related frame is sent to an upper layer for unicast quality of service (QOS) data frames of each traffic identifier (TID) with a block acknowledgement (BA) agreement.

In an embodiment, the group of AP MLDs includes the current serving AP MLD and the new serving AP MLD.

In an embodiment, the AP device includes an AP MLD compatible with an Institute of Electrical and Electronics Engineers (IEEE) 802.11 protocol.

In an embodiment, an access point (AP) multi-link device (MLD) compatible with an Institute of Electrical and Electronics Engineers (IEEE) 802.11 protocol includes a controller configured to determine a frame exchange context for frame exchanges with a non-AP MLD roaming from a current serving AP MLD affiliated with a roaming MLD group identifying address to a new serving AP MLD affiliated with the roaming MLD group identifying address, where the roaming MLD group identifying address is used to identity a group of AP MLDs for association or key negotiation with the non-AP MLD, and a wireless transceiver configured to conduct the frame exchanges with the non-AP MLD based on the frame exchange context.

In an embodiment, the frame exchange context includes information for downlink (DL) frame transmission from the new serving AP MLD to the non-AP MLD or information for uplink (UL) frame reception at the new serving AP MLD from the non-AP MLD.

In an embodiment, the frame exchange context includes information regarding whether the non-AP MLD's emergency preparedness communications service (EPCS) is enabled.

In an embodiment, a method for wireless communications involves at a group of access point (AP) multi-link devices (MLDs) identified by a roaming MLD group identifying address, determining a frame exchange context for frame exchanges with a non-AP device roaming from a current serving AP MLD affiliated with the roaming MLD group identifying address to a new serving AP MLD affiliated with the roaming MLD group identifying address and conducting the frame exchanges with the non-AP device based on the frame exchange context.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link (ML) communications system that is used for wireless (e.g., WiFi) communications in accordance with an embodiment of the invention.

FIG. 2 depicts an ML communications system that is used for wireless (e.g., WiFi) communications in accordance with an embodiment of the invention.

FIG. 3 illustrates an example roaming operation of a non-AP MLD that roams within a wireless network (e.g., a WLAN).

FIG. 4 depicts a wireless device in accordance with an embodiment of the invention.

FIG. 5 depicts a frame exchange sequence diagram between an AP MLD and a non-AP roaming MLD/STA MLD.

FIG. 6 depicts a frame exchange sequence diagram between an AP MLD (also referred to as “the current serving AP MLD”), an AP MLD (also referred to as “the new serving AP MLD”), and a non-AP roaming MLD/STA MLD.

FIG. 7 depicts a frame exchange sequence diagram between an AP MLD ((also referred to as “the current serving AP MLD”), an AP MLD (also referred to as “the new serving AP MLD”), and a non-AP roaming MLD/STA MLD.

FIG. 8 depicts an example block acknowledgement (ACK) architecture.

FIG. 9 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated station (STA) MLD (also referred to as a non-AP MLD in the document). The AP MLD may be configured to operate with associated STA MLDs according to a communication protocol. For example, the communication protocol may be an Institute of Electrical and Electronics Engineer (IEEE) 802.11 communication protocol.

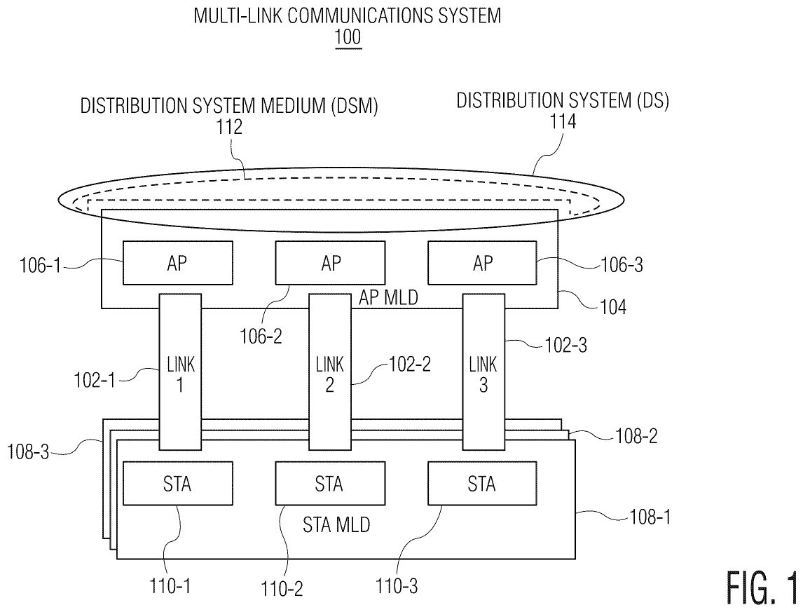

FIG. 1 depicts a multi-link (ML) communications system 100 that is used for wireless (e.g., WiFi) communications in accordance with an embodiment of the invention. In the embodiment depicted in FIG. 1, the multi-link communications system includes at least one AP multi-link device (MLD) 104, and one or more non-AP multi-link devices, which are, for example, implemented as station (STA) MLDs 108-1, 108-2, 108-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 104 and the STA MLDs 108-1, 108-2, 108-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 104 includes multiple radios, implemented as APs 106-1, 106-2, 106-3. In some embodiments, the AP MLD 104 is an AP multi-link logical device or an AP multi-link logical entity (MLLE). In some embodiments, a common part of the AP MLD 104 implements upper layer Media Access Control (MAC) functionalities (e.g., beaconing, association establishment, reordering of frames, etc.) and a link specific part of the AP MLD 104, i.e., the APs 106-1, 106-2, 106-3, implement lower layer MAC functionalities (e.g., backoff, frame transmission, frame reception, etc.). The APs 106-1, 106-2, 106-3 may be implemented in hardware (e.g., circuits), software, firmware, or a combination thereof. At least one of the APs 106-1, 106-2, 106-3 may be fully or partially implemented as an integrated circuit (IC) device. In some embodiments, the AP MLD and its affiliated APs 106-1, 106-2, 106-3 are compatible with at least one wireless local area network (WLAN) communications protocol (e.g., at least one IEEE 802.11 protocol, such as, an IEEE 802.11bn protocol). For example, the APs 106-1, 106-2, 106-3 may be wireless APs compatible with at least one WLAN communications protocol (e.g., at least one IEEE 802.11 protocol, such as, an IEEE 802.11bn protocol).

In some embodiments, an AP MLD (e.g., the AP MLD 104) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol (e.g., an IEEE 802.11bn protocol). In some embodiments, an AP (e.g., the AP 106-1, the AP 106-2, and/or the AP 106-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 106-1, 106-2, 106-3 of the AP MLD 104 operates in different frequency bands. For example, at least one of the APs 106-1, 106-2, 106-3 of the AP MLD 104 operates in a 2.4/5/6 Gigahertz (GHz) frequency band. For example, the AP 106-1 may operate at 6 Gigahertz (GHz) band (e.g., in a 320 MHz (one million hertz) Basic Service Set (BSS) operating channel or other suitable BSS operating channel), the AP 106-2 may operate at 5 GHz band (e.g., a 160 MHz BSS operating channel or other suitable BSS operating channel), and the AP 106-3 may operate at 2.4 GHz band (e.g., a 20 MHz BSS operating channel or other suitable BSS operating channel). In the embodiment depicted in FIG. 1, the AP MLD 104 is connected to a distribution system (DS) 114 through a distribution system medium (DSM) 112. The DS 114 may be a wired network or a wireless network that is connected to a backbone network such as the Internet. The DSM 112 may be a wired medium (e.g., Ethernet cables, telephone network cables, or fiber optic cables) or a wireless medium (e.g., infrared, broadcast radio, cellular radio, or microwaves). Although the AP MLD 104 is shown in FIG. 1 as including three APs, other embodiments of the AP MLD 104 may include fewer than three APs or more than three APs. In addition, although some examples of the DSM 112 are described, the DSM 112 is not limited to the examples described herein.

In the embodiment depicted in FIG. 1, the STA MLD 108-1 includes radios, which are implemented as multiple non-AP stations (STAs) 110-1, 110-2, 110-3. The STAs 110-1, 110-2, 110-3 may be implemented in hardware (e.g., circuits), software, firmware, or a combination thereof. At least one of the STAs 110-1, 110-2, 110-3 may be fully or partially implemented as an IC device. In some embodiments, the non-AP STAs 110-1, 110-2, 110-3 are part of the STA MLD 108-1, such that the STA MLD may be a communications device that wirelessly connects to a wireless AP MLD, such as, the AP MLD 104. For example, the STA MLD 108-1 (e.g., at least one of the non-AP STAs 110-1, 110-2, 110-3) may be implemented in a laptop, a desktop personal computer (PC), a mobile phone, or other communications device that supports at least one WLAN communications protocol. In some embodiments, the STA MLD and its affiliated STAs 110-1, 110-2, 110-3 are compatible with at least one IEEE 802.11 protocol (e.g., an IEEE 802.11bn protocol). In some embodiments, each of the non-AP STAs 110-1, 110-2, 110-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 108. In some embodiments, the STA MLD 108-1 implements a common MAC data service interface and the non-AP STAs 110-1, 110-2, 110-3 implement a lower layer MAC data service interface. In some embodiments, the AP MLD 104 and/or the STA MLDs 108-1, 108-2, 108-3 identify which communications links support the multi-link operation during a multi-link operation setup phase and/or exchanges information regarding multi-link capabilities during the multi-link operation setup phase. Each of the STAs 110-1, 110-2, 110-3 of the STA MLD may operate in a different frequency band. For example, at least one of the STAs 110-1, 110-2, 110-3 of the STA MLD 108-1 operates in the 2.4/5/6 GHz frequency band. For example, the STA 110-1 may operate at 6 GHz band (e.g., in a 320 MHz (one million hertz) BSS operating channel or other suitable BSS operating channel), the STA 110-2 may operate at 5 GHz band (e.g., a 160 MHz BSS operating channel or other suitable BSS operating channel), and the STA 110-3 may operate at 2.4 GHz band (e.g., a 20 MHz BSS operating channel or other suitable BSS operating channel). Although the STA MLD 108-1 is shown in FIG. 1 as including three non-AP STAs, other embodiments of the STA MLD 108-1 may include fewer than three non-AP STAs or more than three non-AP STAs.

Each of the MLDs 108-2, 108-3 may be the same as or similar to the MLD 108-1. For example, the MLD 108-2 or 108-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 108-1 communicates with the AP MLD 104 through multiple communications links 102-1, 102-2, 102-3. For example, each of the STAs 110-1, 110-2, 110-3 communicates with an AP 106-1, 106-2, or 106-3 through a corresponding wireless communications link 102-1, 102-2, or 102-3. Although the AP MLD 104 communicates (e.g., wirelessly communicates) with the STA MLD 108-1 through multiple links 102-1, 102-2, 102-3, in other embodiments, the AP MLD 104 may communicate (e.g., wirelessly communicate) with the STA MLD through more than three communications links or less three than communications links. In some embodiments, the communications links in the multi-link communications system are wireless communications links, which may include one or more 2.4/5/6 GHz links.

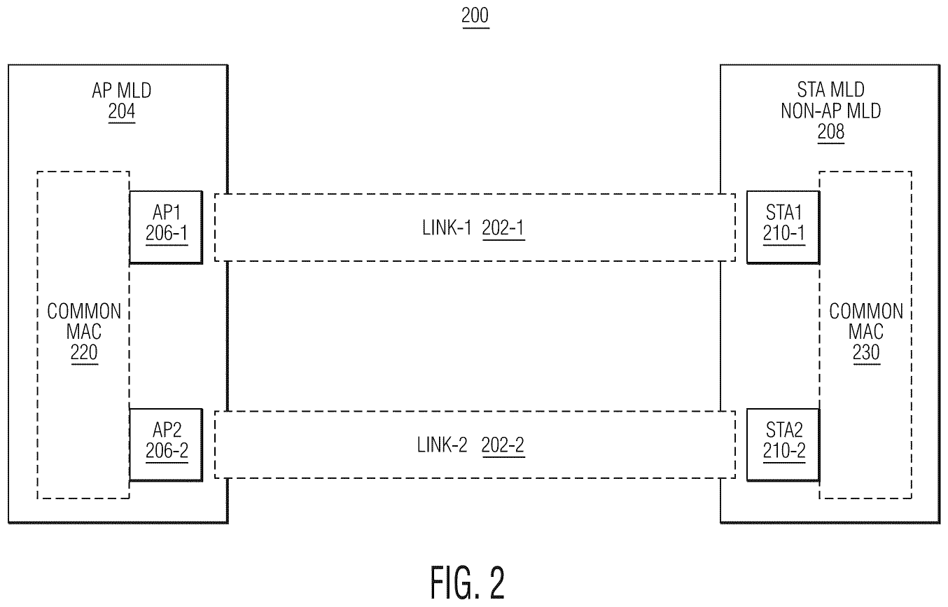

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common MAC 220 of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, a common MAC 230 of the STA MLD 208 implements upper layer Media Access Control (MAC) functionalities (e.g., beaconing, association establishment, reordering of frames, etc.) and a link specific part of the STA MLD 208, i.e., the STAs 210-1 and 210-2, implement lower layer MAC functionalities (e.g., backoff, frame transmission, frame reception, etc.). For example, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

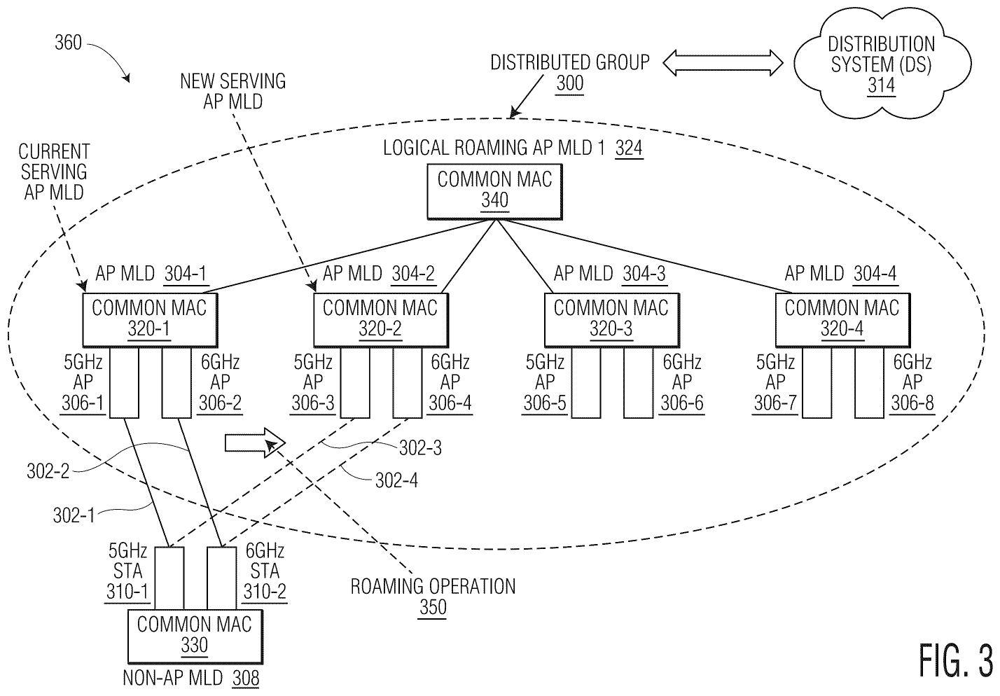

FIG. 3 illustrates an example roaming operation 350 of a non-AP MLD 308 that roams within a wireless network (e.g., a WLAN) 360. In the example roaming operation 350 illustrated in FIG. 3, a logical roaming AP MLD 324 includes a number of affiliated AP MLDs 304-1, 304-2, 304-3, 304-4, which may be located in substantially different physical/geographic locations. Together they operate as a distribution group 300 (e.g., a mobility domain) having a common MAC service access point (SAP) address (e.g., a “Common MAC” 340 shown in FIG. 3). In the example roaming operation 350 illustrated in FIG. 3, the roaming AP MLD 324 is a logical MLD that itself may be a separate physical entity or located in one of AP MLDs 304-1, 304-2, 304-3, 304-4, which are typically scattered in different geographical locations. Typically, the non-AP MLDs with non-AP MLD 308 as an example in the figure (e.g., a vehicle or person's smartphone) may “move” between the “different geographical locations” and a hitless/seamless handoff experience is provided to the non-AP MLD 308 using the “Common MAC” address.

Seamless (i.e., hitless) or smooth roaming is a type of wireless roaming that allows a non-AP device (e.g. a mobile device) to switch between different AP devices without interrupting frame exchanges of the non-AP device, which means the non-AP device can maintain a continuous connection to a roaming AP MLD, a distribution system (DS), an ESS, a network, etc. while physically moving, without the need for additional association. In some embodiments, a non-AP MLD has one serving AP MLD for its frame exchanges when the non-AP MLD does not carry out roaming or finishes it roaming. In another embodiment, a non-AP MLD can have multiple serving AP MLDs for its frame exchanges when the non-AP MLD does not carry out roaming or finishes it roaming. For a non-AP MLD, the roaming AP may be a logical entity that exists in the current serving AP MLD of a non-AP MLD.

In some embodiments, each of the AP MLDs 304-1, 304-2, 304-3, 304-4 has its own unique ID (identifier) in the distributed (e.g. logical roaming) AP MLD group 300. These unique IDs may each have a different ID space. In another embodiment, each of the AP MLDs 304-1, 304-2, 304-3, 304-4 is identified by its unique MAC service access point (SAP) address (AP MLD address). In other words, each AP MLD in a roaming AP MLD is identified by its MAC SAP address, which means that the additional ID is not needed.

Each of the AP MLDs 304-1, 304-2, 304-3, 304-4 may include multiple APs that operate in different frequency bands. For example, the AP MLD 304-1 may include 5 GHz AP 306-1 that operates in 5 GHz frequency band (also referred to as 5 GHz AP 306-1) and 6 GHz AP 306-2 that operates in 6 GHz frequency band (also referred to as 6 GHz AP 306-2), the AP MLD 304-2 includes 5 GHZ AP 306-3 and 6 GHZ AP 306-4, the AP MLD 304-3 includes 5 GHz AP 306-5 and 6 GHz AP 306-6, and the AP MLD 304-4 includes 5 GHz AP 306-7 and 6 GHz AP 304-8.

The non-AP MLD 308 may include multiple STAs that operate in different frequency bands. For example, the non-AP MLD 308 may include 5 GHz STA 310-1 that operates in 5 GHz frequency band and 6 GHz STA 310-2 that operates in 6 GHz frequency band, which are shown as having already established a multi-link association with the logical roaming AP MLD 324 through the AP MLD 304-1 (e.g., a serving AP MLD). There are two setup links 302-1 and 302-2 between the AP MLD 304-1 and the non-AP MLD 308. The link 302-1 is between the 5 GHz AP 306-1 and the 5 GHz STA 310-1. The link 302-2 is between the 6 GHz AP 306-2 and the 6 GHz STA 310-2. Thus, the non-AP MLD 308 can execute data frame exchanges with the serving AP MLD 304-1 affiliated with the logical roaming AP MLD 324.

In some embodiments, the non-AP MLD 308 is mobile and can physically move within the logical roaming AP MLD 324. Therefore, the non-AP MLD 308 may roam from one AP MLD 304-1 (i.e., a current serving AP MLD) affiliated with the logical roaming AP MLD 324 to another AP MLD 304-2 (i.e., a new or future serving AP MLD) affiliated with the logical roaming AP MLD 324 without a need for reassociation and/or Pairwise Master Key (PMK)/Pairwise Transient Key (PTK) renegotiation (i.e., hitless/seamless roaming). Through the roaming operation 350, the non-AP MLD 308 establishes new setup links 302-3 and 302-4 between the AP MLD 304-2 and the non-AP MLD 308, and a frame exchange context of the non-AP MLD 308 is transferred from the current serving AP MLD 304-1 to the new serving AP MLD 304-2 for future frame exchanges. The new link 302-3 is between the 5 GHz AP 306-3 and the 5 GHz STA 310-1, and the new link 302-4 is between the 6 GHZ AP 306-4 and the 6 GHz STA 310-2. In some embodiments, except the roaming stage, the non-AP MLD 308 always has one serving AP MLD to perform the frame exchanges for class 3 frames allowed by the state after the association and authentication for key establishment (e.g., state 4 in 802.11).

In some example embodiments, a distribution system (DS) 314 connects the APs 306-1, 306-2, 306-3, 306-4, 306-5, 306-6, 306-7, 306-8 into an Extended Service Set (ESS). An ESS can include any combination of one or more logical roaming AP MLDs, one or more AP MLDs, and one or more APs. In some example embodiments, more than one logical roaming AP MLD can exist in a single ESS.

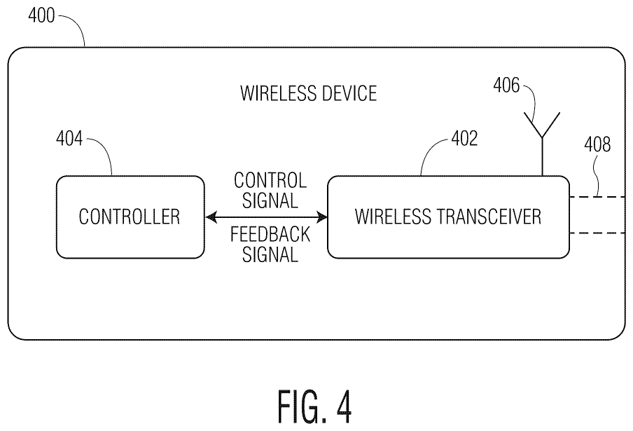

FIG. 4 depicts a wireless device 400 in accordance with an embodiment of the invention. The wireless device 400 can be used in the ML communications system 100 depicted in FIG. 1, the ML communications system 200 depicted in FIG. 2, and/or the wireless network 360 depicted in FIG. 3. For example, the wireless device 400 may be an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the APs 306-1, 306-2, 306-3, 306-4, 306-5, 306-6, 306-7, 306-8 depicted in FIG. 3, and/or the STAs 310-1, 310-2 depicted in FIG. 3. In the embodiment depicted in FIG. 4, the wireless device 400 includes a wireless transceiver 402, a controller 404 operably connected to the wireless transceiver, and at least one antenna 406 operably connected to the wireless transceiver. In some embodiments, the wireless device 400 may include at least one optional network port 408 operably connected to the wireless transceiver. The wireless device 400 may be fully or partially implemented as an IC device. In some embodiments, the wireless transceiver 402 and/or the controller 404 may be implemented in a single chip. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 400 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 402 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 404 is configured to determine a frame exchange context for frame exchanges with a non-AP device roaming from a current serving AP MLD affiliated with a roaming MLD group identifying address to a new serving AP MLD affiliated with the roaming MLD group identifying address, and the wireless transceiver 402 is configured to conduct the frame exchanges with the non-AP device based on the frame exchange context. In some embodiments, the roaming MLD group identifying address includes a common Media Access Control (MAC) address that is used to identity a group of AP MLDs for association or key negotiation with the non-AP device and to identify the new serving AP MLD to which the non-AP device is roamed to. In some embodiments, the frame exchange context includes information for downlink (DL) frame transmission from the new serving AP MLD to the non-AP device. In some embodiments, the information for DL frame transmission includes pairwise transient key (PTK) information and smallest unallocated packet number (PN) information, i.e., the next PN that can be allocated to the unicast Data and Management frame, for unicast data frame or management frame transmission. In some embodiments, the information for DL frame transmission includes a smallest unallocated sequence number (SN) of a SN space for unicast quality of service (QOS) data frames of each traffic identifier (TID) addressed to the non-AP device and a start of an originator window information when the current serving AP MLD and the new serving AP MLD transmit QoS data frames during a roaming procedure. In some embodiments, the information for DL frame transmission includes a smallest unallocated SN of a SN space for unicast management frames addressed to the non-AP device. In some embodiments, the frame exchange context includes information for uplink (UL) frame reception at the new serving AP MLD from the non-AP device. In some embodiments, the information for UL frame reception includes pairwise transient key (PTK) information and a replay counter of packet number (PN) information for each traffic identifier (TID) of unicast data frame reception or a replay counter of PN information for management frame reception. In some embodiments, the information for UL frame reception includes a largest SN of a SN space whose related frame is sent to an upper layer for unicast quality of service (QOS) data frames of each traffic identifier (TID) from the non-AP device. In some embodiments, the information for UL frame reception includes a largest SN of a SN) space whose related frame is sent to an upper layer for unicast management frames from the non-AP device. In some embodiments, the frame exchange context includes information regarding whether the non-AP device's emergency preparedness communications service (EPCS) is enabled. In some embodiments, the non-AP device includes a non-AP MLD. In some embodiments, the controller is further configured to determine the frame exchange context for the frame exchanges between the new serving AP MLD and the non-AP device based on a frame exchange context for frame exchanges between the current serving AP MLD and the non-AP device. In some embodiments, the frame exchange context for the frame exchanges between the current serving AP MLD and the non-AP device includes reorder buffer information of the current serving AP MLD. In some embodiments, the current serving AP MLD notifies the non-AP device a largest sequence number (SN) of a SN space whose related frame is sent to an upper layer for unicast quality of service (QOS) data frames of each traffic identifier (TID) with a block acknowledgement (BA) agreement. In some embodiments, the group of AP MLDs includes the current serving AP MLD and the new serving AP MLD. In some embodiments, the AP device includes an AP MLD compatible with an Institute of Electrical and Electronics Engineers (IEEE) 802.11 protocol. In some embodiments, the wireless device 400 is compatible with an Institute of Electrical and Electronics Engineers (IEEE) 802.11 protocol.

In some cases, a roaming AP MLD includes distributed multiple AP MLDs. The roaming AP MLD may be invisible to a non-AP MLD that does not support smooth roaming. A non-AP MLD that supports smooth roaming can associate with the roaming AP MLD, establish the PTK with the roaming AP MLD, establish the block acknowledgement (BA) agreement with the roaming AP MLD, and have sequence number (SN) space of unicast data frames at the roaming MLD level. The simultaneous transmit and receive (STR), non-simultaneous transmit and receive (NSTR), enhanced multi-link single radio (EMLSR)/enhanced multi-link multi-radio (EMLMR), multi-link single radio (MLSR), Traffic Identifier (TID)-to-link mapping, transmission (Tx) of group-addressed frames can be performed at MLD level.

Some implementations of information transfer during smooth AP MLD roaming, for example, by the ML communications system 100 depicted in FIG. 1, the ML communications system 200 depicted in FIG. 2, and/or the wireless network 360 depicted in FIG. 3 are described.

In some embodiments, frame exchange context information of a non-AP MLD being transferred from a current serving AP MLD to a new serving AP MLD includes information for downlink (DL) frame transmission (Tx). For example, the frame exchange context information of the non-AP MLD being transferred from the current serving AP MLD to the new serving AP MLD may include PTK, packet number (PN) for unicast data frames and management frames (e.g., the next unallocated PN in the PN space), sequence number (SN) space for unicast Quality of Service (QOS) data frames of each TID addressed to the non-AP MLD that undergoes the smooth roaming (e.g., the next unallocated SN in the SN space), BA agreement parameters (buffer size etc.), SN space for unicast management frames addressed to the non-AP MLD needs to allocate the SN at MLD level (e.g., the unallocated SN in the SN space), and/or if protected management frame (PMF) is enabled by the non-AP MLD, SN space for unicast management frames of each AC (Access Category) addressed to the non-AP MLD needs to allocate the SN at MLD level (e.g., the unallocated SN in the SN space of each AC). In some embodiments, the unicast control frame protection and frame header protection may use the same PN.

In some embodiments, frame exchange context information of a non-AP MLD being transferred from a current serving AP MLD to a new serving AP MLD includes information for uplink (UL) frame reception (Rx). For example, the frame exchange context information of the non-AP MLD being transferred from the current serving AP MLD to the new serving AP MLD may include PTK (same as PTK in Tx part), PN for unicast data frames, and management frames (e.g., one replay counter for unicast QoS Data frames each TID and/or one replay counter for management frame if PMF is not used or one replay counter for management frames of each AC), SN space for unicast QoS data frames of each TID from the non-AP MLD that does the smooth roaming (e.g., the duplicate detection cache for each TID that has no BA agreement and/or the last SN to be sent to the up layer of a BA agreement), BA agreement parameters (buffer size etc.), SN space for unicast management frames from the non-AP MLD needs to allocate the SN at MLD level (e.g., the duplication detection cache for the unicast management frames), and/or if PMF is enabled by the non-AP MLD, SN space for unicast management frames of each AC from the non-AP MLD needs to allocate the SN at MLD level (e.g., the duplication detection cache for the unicast management frames of each AC of PMF management frames). In some embodiments, the unicast control frame protection and frame header protection may use the same PN.

In some embodiments, the selection of whether a non-AP MLD's emergency preparedness communications service (EPCS) is enabled will be transferred from a current roaming AP MLD to a new serving AP MLD. In some embodiments, Enhanced Distributed Channel Access (EDCA) parameters and multi-user (MU) EDCA parameters for EPCS service are not transferred from the current AP MLD to the new serving AP MLD. In some embodiments, if/when proxy Address Resolution Protocol (ARP) is supported, the proxy ARP for non-AP MLD is established at the new serving AP MLD. As a general rule, when the non-AP MLD establishes a service with the outside server (e.g., through an IEEE 802.11u protocol), the service being enabled in the current serving AP MLD will be still enabled at the new serving AP MLD.

Some implementations of UL TID with BA agreement, for example, by the ML communications system 100 depicted in FIG. 1, the ML communications system 200 depicted in FIG. 2, and/or the wireless network 360 depicted in FIG. 3 are described.

The BA reorder buffer of the current serving AP MLD may be moved to the new serving AP MLD or may not be moved to the new serving AP MLD. In some embodiments, if/when the new serving AP MLD has no reorder buffer information of the current serving AP MLD where the current AP MLD send all the frames in its reorder buffer to the up layer, the WinStartB in the new serving AP MLD will be the SN that is not less than the largest sequence number of the frame that is set to the upper layer for the further processing. The retransmission of the frames whose sequence numbers are less than WinStartB of the new serving AP MLD may be discarded by the new serving AP MLD after roaming to the new serving AP MLD. In some embodiments, the serving AP MLD notifies the non-AP MLD that is doing or executing the smooth roaming the largest SN of the frame being sent to the up layer (or the WinStartB in the new serving AP MLD). In the scenario where the current serving AP MLD sends all the frames in its reorder buffer to the up layer, the non-AP MLD being doing smooth roaming discards the frames in the retransmitted buffer (transmit buffer control) whose SNs are less than the largest SN being acquired from the current serving AP MLD. In some embodiments, if/when the new serving AP MLD acquires the reorder buffer information of the current serving AP MLD, the WinStartB in the new serving AP MLD will be the same as the WinStartB of the current serving AP MLD. The discarding of the frames in Transmit Buffer may create unnecessary frame discarding. In some embodiments, the serving AP MLD notifies the non-AP MLD that is doing or executing the smooth roaming the largest SN of the frame being sent to the up layer (or the WinStartB in the new serving AP MLD). In the scenario where the current serving AP MLD sends all the frames in its reorder buffer to the new serving AP MLD as the new AP MLD's reorder buffer, the non-AP MLD being doing smooth roaming continues the retransmission of the frames that are not transmitted successfully. The new serving AP MLD may not have enough resource to support the BA agreement as a BA agreement recipient. In some embodiments, the new serving AP MLD may notify the roaming non-AP MLD the new BA buffer size of the updated BA agreement. In some embodiments, the scoreboard context should not be moved from the current serving AP MLD to the new serving AP. In some embodiments, the new AP MLD flushes its scoreboard context of the roaming non-AP MLD.

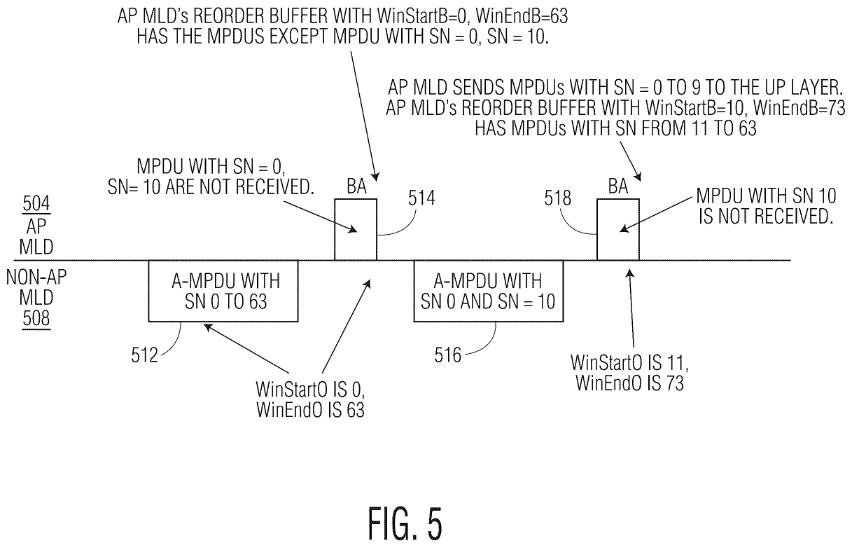

FIG. 5 depicts a frame exchange sequence diagram between an AP MLD 504 and a non-AP roaming MLD/STA MLD 508. In the frame exchange sequence diagram depicted in FIG. 5, the AP MLD 504 may be implemented the same as or similar to the AP MLD 104 depicted in FIG. 1, the AP MLD 204 depicted in FIG. 2, and/or the AP MLDs 304-1, 304-2, 304-3, 304-4 depicted in FIG. 3, while the non-AP MLD/STA MLD 508 may be implemented the same as or similar to the STA MLDs 108-1, 108-2, 108-3 depicted in FIG. 1, the STA MLD 208 depicted in FIG. 2, and/or the STA MLD 308 depicted in FIG. 3, respectively. In the frame exchange sequence diagram depicted in FIG. 5, the non-AP MLD 508 that is the originator of the BA agreement for UL A-MPDU transmission is the transmit opportunity (TXOP) holder. In some embodiments, a link aggregator originator window is defined by the start of the window (WinStartO), the end of the window is represented as WinEndO, and the size of the window is represented as WinSizeO. The non-AP MLD 508 (through one of its associated STAs) may transmit an Aggregated Mac Protocol Data Unit (A-MPDU) 512 with a SN of 0 to 63 (WinStartO is 0, WinEndO is 63) and the AP MLD 504's reorder buffer with WinStartB=0, WinEndB=63 has the MPDUs except MPDU with SN=0, SN=10 being not received correctly. The AP of the AP MLD 504 that receives the A-MPDU may transmit a BA frame 514 back to the non-AP MLD 508, indicating that MPDUs with SN=0, SN=10 have not been received. The non-AP MLD 508 may transmit an A-MPDU 516 with SN=0, SN=10. The AP of the AP MLD 504 that receives the A-MPDU may transmit a BA frame 514 back to the non-AP MLD 508, indicating that MPDU with SN=10 has not been received. The AP MLD 504 sends MPDUs with SN=0 to 9 to the up layer. AP MLD's reorder buffer with WinStartB=10, WinEndB=73 has MPDUs with SN from 11 to 63. The non-AP MLD 508 has WinStartO is 11, WinEndO is 73.

In some embodiments, the current serving AP MLD notifies the new serving AP MLD the largest SN to be sent to the up layer. In some embodiments, the new serving AP MLD uses the largest SN+1 as its WinStartB. The current serving AP MLD may also forward the buffer frames in its reorder buffer of a BA agreement to the new serving AP MLD. In some embodiments, the new serving AP MLD notifies the non-AP MLD the WinStartB (or the largest SN to be sent to the up layer) of each UL TID with the BA agreement, or the current serving AP MLD notifies the non-AP MLD the WinStartB (or the largest SN to be sent to the up layer) of each UL TID with the BA agreement on the new serving AP MLD (or whether the frames in reorder buffer are forward to the new serving AP MLD). In some embodiments, the non-AP MLD uses the WinStartB as its WinStartO. In some embodiments, the new serving AP MLD flushes its scoreboard context for the non-AP MLD. In some embodiments, if/when the new serving AP MLD maintains the WinStartR, the new serving AP MLD notifies the non-AP MLD the WinStartR of each UL TID with the BA agreement. In some embodiments, the non-AP MLD uses the WinStartR instead of WinStartB as its WinStartO. The new serving AP MLD may tear down the BA agreement. In another variant, the new serving AP MLD may indicate the new BA agreement buffer size that the serving AP MLD accepts.

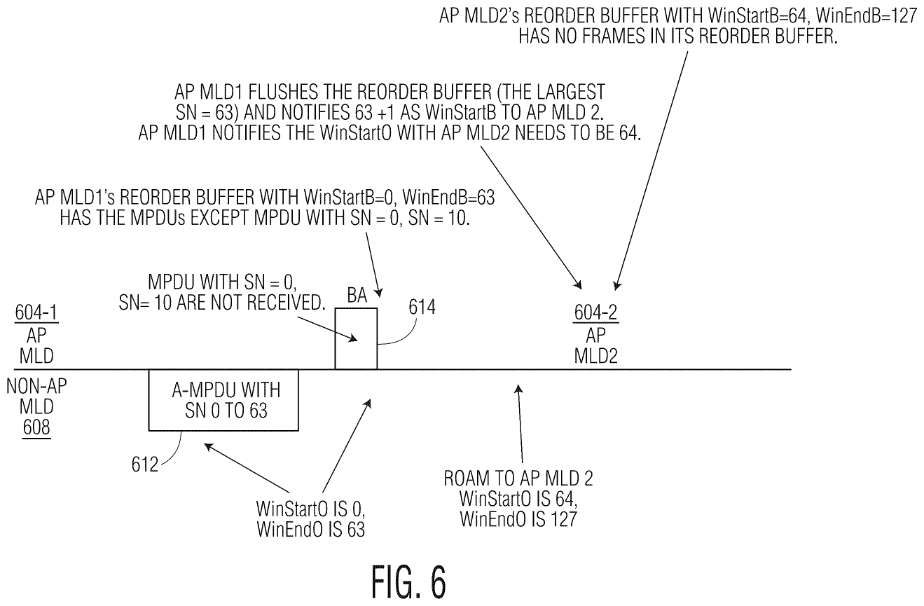

FIG. 6 depicts a frame exchange sequence diagram between an AP MLD 604-1 (also referred to as “the current serving AP MLD”), an AP MLD 604-2 (also referred to as “the new serving AP MLD”), and a non-AP roaming MLD/STA MLD 608. In the frame exchange sequence diagram depicted in FIG. 6, the AP MLDs 604-1, 604-2 may be implemented the same as or similar to the AP MLD 104 depicted in FIG. 1, the AP MLD 204 depicted in FIG. 2, and/or the AP MLDs 304-1, 304-2, 304-3, 304-4 depicted in FIG. 3, while the non-AP MLD/STA MLD 608 may be implemented the same as or similar to the STA MLDs 108-1, 108-2, 108-3 depicted in FIG. 1, the STA MLD 208 depicted in FIG. 2, and/or the STA MLD 308 depicted in FIG. 3, respectively. In the frame exchange sequence diagram depicted in FIG. 6, the non-AP MLD 608 is doing or executing the smooth roaming. The non-AP MLD 608 being the TXOP holder in one of its setup links may transmit an Aggregated Mac Protocol Data Unit (A-MPDU) 612 with a SN of 0 to 63 (the non-AP MLD has WinStartO being 0, WinEndO being 63). The current serving AP MLD 604-1 may transmit a BA frame 614 back to the non-AP MLD 608, indicating that MPDUs with SN=0, SN=10 have not been received. The current serving AP MLD 604-1's reorder buffer with WinStartB=0, WinEndB=63 has the MPDUs except MPDU with SN=0, SN=10. The non-AP MLD 608 roams from the current serving AP MLD 604-1 to the new serving AP MLD 604-2 (WinStartO is 64, WinEndO is 127). The current serving AP MLD 604-1 flushes the reorder buffer (the largest SN=63) and Notifies 63+1 as WinStartB to the new serving AP MLD 604-2 (or notifies the frames with largest SN equal to 63 being sent to the up layer). The current serving AP MLD 604-1 notifies the non-AP MLD 608 the frames with largest SN equal to 63 being sent to the up layer (or notifies the WinStartB of the new serving AP MLD being equal to 64). The non-AP MLD 608 sets its WinStartO with the new serving AP MLD 604-2 being 64. The new serving AP MLD 604-2's reorder buffer with WinStartB=64, WinEndB=127 has no frames in its reorder buffer.

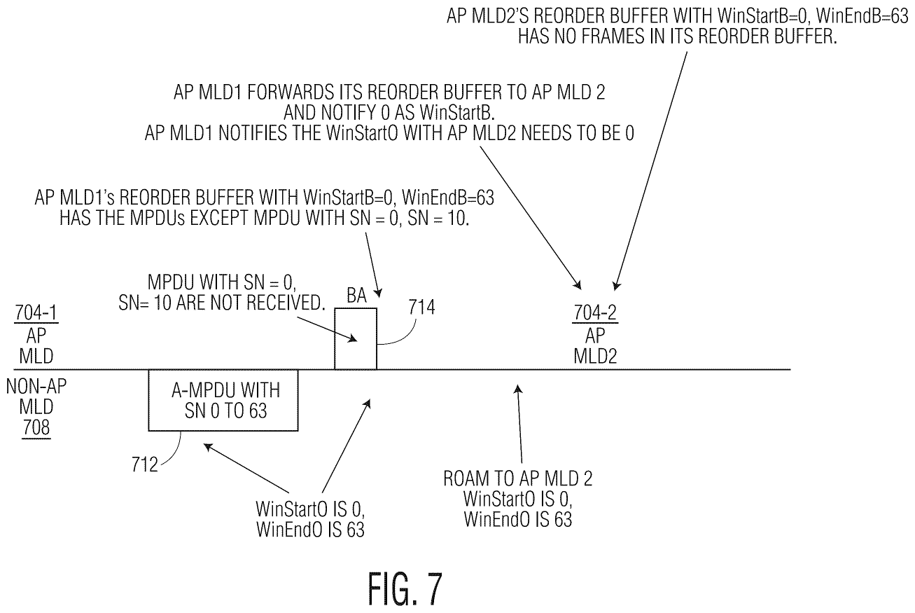

FIG. 7 depicts a frame exchange sequence diagram between an AP MLD 704-1 (the current serving AP MLD), an AP MLD 704-2 (the new serving AP MLD), and a non-AP roaming MLD/STA MLD 708. In the frame exchange sequence diagram depicted in FIG. 7, the AP MLDs 704-1, 704-2 may be implemented the same as or similar to the AP MLD 104 depicted in FIG. 1, the AP MLD 204 depicted in FIG. 2, and/or the AP MLDs 304-1, 304-2, 304-3, 304-4 depicted in FIG. 3, while the non-AP MLD/STA MLD 708 may be implemented the same as or similar to the STA MLDs 108-1, 108-2, 108-3 depicted in FIG. 1, the STA MLD 208 depicted in FIG. 2, and/or the STA MLD 308 depicted in FIG. 3, respectively. In the frame exchange sequence diagram depicted in FIG. 7, the non-AP MLD 708 is executing the smooth roaming. One STA of the non-AP MLD 708 as the TXOP holder may transmit an Aggregated Mac Protocol Data Unit (A-MPDU) 712 with a SN of 0 to 63 (non-AP MLD has WinStartO being 0, WinEndO being 63). The current serving AP MLD 704-1 may transmit a BA frame 714 back to the non-AP MLD 708, indicating that MPDUs with SN=0, SN=10 have not been received. The current serving AP MLD 704-1's reorder buffer with WinStartB=0, WinEndB=63 has the MPDUs except MPDU with SN=0, SN=10. The non-AP MLD 708 roams from the current serving AP MLD 704-1 to the new serving AP MLD 704-2 (WinStartO is 0, WinEndO is 63). The current serving AP MLD 704-1 forwards its reorder buffer to the new serving AP MLD 704-2 and notify 0 as WinStartB. The current serving AP MLD 704-1 notifies the non-AP MLD 708 that the WinStartB of the new serving AP MLD being equal to 0. The non-AP MLD 708 sets WinStartO with the new serving AP MLD 704-2 to 0. The new serving AP MLD 604-2's reorder buffer with WinStartB=0, WinEndB=63 has the frames with SN equal to 0 to 63 except the frames with SN=0 and SN=10 in its reorder buffer.

In some embodiments, it is up to a roaming AP MLD to decide whether the transmit buffer control is moved from a current serving AP MLD to a new serving AP MLD. In another variant, a non-AP MLD may notify the new serving AP MLD the WinStartO of each DL TID with the BA agreement when performing smooth roaming procedure with the new serving AP MLD. The new serving AP MLD or the current serving AP MLD may notify the non-AP MLD its WinStartO. In some embodiments, the non-AP MLD uses the WinStartO to update its WinStartB and WinStartR. In another variant, the BAR is used for such operation. In some embodiments, the current serving AP MLD and the new serving AP MLD may send the DL frames of a TID with BA agreement to the non-AP MLD during the roaming procedure. In some embodiments, the current serving AP MLD notifies the new serving AP MLD the WinStartO besides the largest SN being allocated to the frames of the TID already. In some embodiments, the new serving AP MLD is not allowed to send the frames with SNs larger than the WinStartO+WinSizeO that is WinEndO.

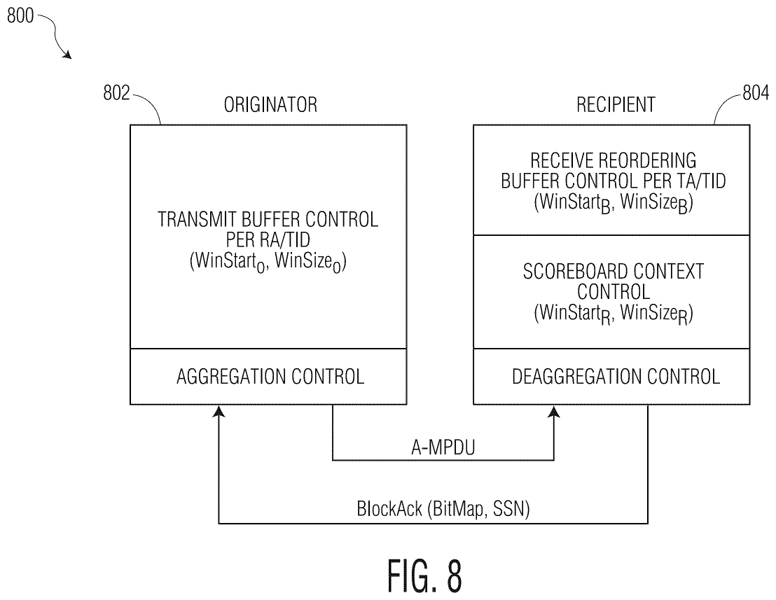

FIG. 8 depicts an example block ACK architecture 800. In the embodiment depicted in FIG. 8, the block ACK architecture 800 includes an originator 802 and a recipient 804. In some embodiments, the originator 802 transmits buffer control per RA/Traffic Identifier (TID) to the recipient 804, which performs scoreboard context control. The originator 802 may perform aggregation control by transmitting A-MPDU to the recipient 804, which may perform deaggregation control by transmitting blockACK (bitmap, Starting Sequence number (SSN)).

Some implementations of PTK, PN of unicast control frame, frame header protection, for example, by the ML communications system 100 depicted in FIG. 1, the ML communications system 200 depicted in FIG. 2, and/or the wireless network 360 depicted in FIG. 3 are described. In some embodiments, when a non-AP MLD switch its serving AP MLD from one AP MLD to another AP MLD, the PTK, PN for unicast data frame, unicast management frame to/from the non-AP MLD do not need to be updated at the new serving AP MLD. However, when a non-AP MLD switch its serving AP MLD from one AP MLD to another AP MLD, the PTK, PN for protected unicast control frames, protected frame headers to/from the non-AP MLD need to be updated at the new serving AP MLD. With such observation, the PTK, PN for protected unicast control frames, protected frame headers can be negotiated separately from the PTK, PN for unicast data frame and management frames. In some embodiments, in a first option, the negotiation of PTK, PN for protected unicast control frames, protected frame headers is performed during the roaming through the negotiation action frames (e.g., Link Reconfiguration Request, Link Reconfiguration Response). In some embodiments, in a second option, the negotiation of PTK, PN for protected unicast control frames, protected frame headers is performed right after the roaming negotiation.

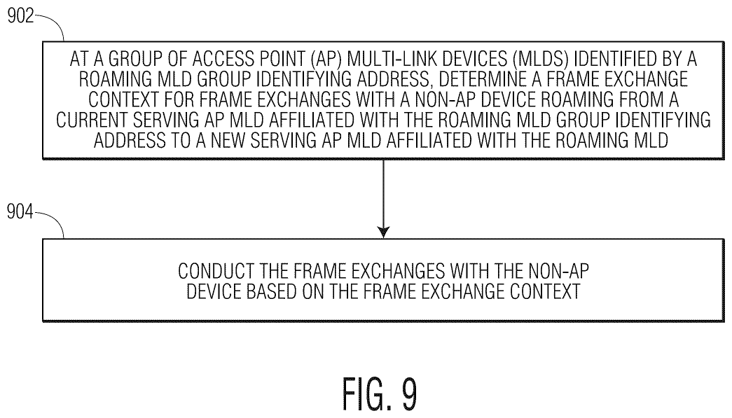

FIG. 9 is a process flow diagram of a method for wireless communications in accordance with an embodiment of the invention. At block 902, at a group of access point (AP) multi-link devices (MLDs) identified by a roaming MLD group identifying address, a frame exchange context for frame exchanges with a non-AP device roaming from a current serving AP MLD affiliated with the roaming MLD group identifying address to a new serving AP MLD affiliated with the roaming MLD group identifying address is determined. At block 904, the frame exchanges are conducted with the non-AP device based on the frame exchange context. In some embodiments, the roaming MLD group identifying address includes a common Media Access Control (MAC) address that is used to identity the group of AP MLDs for association or key negotiation with the non-AP device and to identify the new serving AP MLD to which the non-AP device is roamed to. In some embodiments, the frame exchange context includes information for downlink (DL) frame transmission from the new serving AP MLD to the non-AP device. In some embodiments, the information for DL frame transmission includes pairwise transient key (PTK) information and smallest unallocated packet number (PN) information for unicast data frame or management frame transmission. In some embodiments, the information for DL frame transmission includes a smallest unallocated sequence number (SN) in a SN space for unicast quality of service (QOS) data frames of each traffic identifier (TID) addressed to the non-AP device and a start of an originator window information when the current serving AP MLD and the new serving AP MLD transmit QoS data frames during a roaming procedure. In some embodiments, the information for DL frame transmission includes a smallest unallocated sequence number (SN) in a SN space for unicast management frames addressed to the non-AP device. In some embodiments, the frame exchange context includes information for uplink (UL) frame reception at the new serving AP MLD from the non-AP device. In some embodiments, the information for UL frame reception includes pairwise transient key (PTK) information and a replay counter of packet number (PN) information for each traffic identifier (TID) of unicast data frame reception or a replay counter of PN information for management frame reception. In some embodiments, the information for UL frame reception includes a largest sequence number (SN) of a SN space whose related frame is sent to an upper layer for unicast quality of service (QOS) data frames of each traffic identifier (TID) from the non-AP device. In some embodiments, the information for UL frame reception includes a largest sequence number (SN) of a SN space whose related frame is sent to an upper layer for unicast management frames from the non-AP device. In some embodiments, the frame exchange context includes information regarding whether the non-AP device's emergency preparedness communications service (EPCS) is enabled. In some embodiments, the non-AP device includes a non-AP MLD. In some embodiments, the controller is further configured to determine the frame exchange context for the frame exchanges between the new serving AP MLD and the non-AP device based on a frame exchange context for frame exchanges between the current serving AP MLD and the non-AP device. In some embodiments, the current serving AP MLD notifies the non-AP device a largest sequence number (SN) of a SN space whose related frame is sent to an upper layer for unicast quality of service (QOS) data frames of each traffic identifier (TID) with a block acknowledgement (BA) agreement. In some embodiments, the group of AP MLDs includes the current serving AP MLD and the new serving AP MLD. In some embodiments, the AP device includes an AP MLD compatible with an Institute of Electrical and Electronics Engineers (IEEE) 802.11 protocol. The current serving AP MLD may be the same as or similar to an embodiment of the AP MLDs 106-1, 106-2, 106-3 depicted in FIG. 1, the AP MLD 204 depicted in FIG. 2, the AP MLD 304-1 depicted in FIG. 3, the wireless device 400 depicted in FIG. 4, the AP MLD 504 depicted in FIG. 5, the AP MLD 604-1 depicted in FIG. 6, and/or the AP MLD 704-1 depicted in FIG. 7. The new serving AP MLD may be the same as or similar to an embodiment of the AP MLDs 106-1, 106-2, 106-3 depicted in FIG. 1, the AP MLD 204 depicted in FIG. 2, the AP MLD 304-2 depicted in FIG. 3, the wireless device 400 depicted in FIG. 4, the AP MLD 504 depicted in FIG. 5, the AP MLD 604-2 depicted in FIG. 6, and/or the AP MLD 704-2 depicted in FIG. 7. The non-AP device may be the same as or similar to an embodiment of the STAs 110-1, 110-2, 110-3 depicted in FIG. 1, the non-AP MLDs 108-1, 108-2, 108-3 depicted in FIG. 1, the STAs 210-1, 210-2 depicted in FIG. 2, the non-AP MLD 208 depicted in FIG. 2, the non-AP MLD 308 depicted in FIG. 3, the wireless device 400 depicted in FIG. 4, the non-AP MLD 508 depicted in FIG. 5, the non-AP MLD 608 depicted in FIG. 6, and/or the non-AP MLD 708 depicted in FIG. 7.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An access point (AP) device comprising:
a controller configured to determine a frame exchange context for a plurality of frame exchanges with a non-AP device roaming from a current serving AP MLD affiliated with a roaming MLD group identifying address to a new serving AP MLD affiliated with the roaming MLD group identifying address; and
a wireless transceiver configured to conduct the frame exchanges with the non-AP device based on the frame exchange context.

2. The AP device of claim 1, wherein the roaming MLD group identifying address comprises a common Media Access Control (MAC) address that is used to identity a group of AP MLDs for association or key negotiation with the non-AP device and to identify the new serving AP MLD to which the non-AP device is roamed to.

3. The AP device of claim 1, wherein the frame exchange context comprises information for downlink (DL) frame transmission from the new serving AP MLD to the non-AP device.

4. The AP device of claim 3, wherein the information for DL frame transmission comprises pairwise transient key (PTK) information and smallest unallocated packet number (PN) information for unicast data frame or management frame transmission.

5. The AP device of claim 3, wherein the information for DL frame transmission comprises a smallest unallocated sequence number (SN) in a SN space for a plurality of unicast quality of service (QOS) data frames of each traffic identifier (TID) addressed to the non-AP device, BA agreement parameters, and a start of an originator window information of BA agreement when the current serving AP MLD and the new serving AP MLD transmit a plurality of QoS data frames during a roaming procedure.

6. The AP device of claim 3, wherein the information for DL frame transmission comprises a smallest unallocated sequence number (SN) in a SN space for a plurality of unicast management frames addressed to the non-AP device.

7. The AP device of claim 2, wherein the frame exchange context comprises information for uplink (UL) frame reception at the new serving AP MLD from the non-AP device.

8. The AP device of claim 7, wherein the information for UL frame reception comprises pairwise transient key (PTK) information and a replay counter of packet number (PN) information for each traffic identifier (TID) of unicast data frame reception or a replay counter of PN information for management frame reception.

9. The AP device of claim 7, wherein the information for UL frame reception comprises BA agreement parameters, a largest sequence number (SN) of a SN space whose related frame is sent to an upper layer for a plurality of unicast quality of service (QOS) data frames of each traffic identifier (TID) from the non-AP device.

10. The AP device of claim 7, wherein the information for UL frame reception comprises a largest sequence number (SN) of a SN space whose related frame is sent to an upper layer for a plurality of unicast management frames from the non-AP device.

11. The AP device of claim 2, wherein the frame exchange context comprises information regarding whether the non-AP device's emergency preparedness communications service (EPCS) is enabled.

12. The AP device of claim 2, wherein the non-AP device comprises a non-AP MLD.

13. The AP device of claim 2, wherein the controller is further configured to determine the frame exchange context for the frame exchanges between the new serving AP MLD and the non-AP device based on a frame exchange context for a plurality of frame exchanges between the current serving AP MLD and the non-AP device.

14. The AP device of claim 13, wherein the current serving AP MLD notifies the non-AP device a largest sequence number (SN) of a SN space whose related frame is sent to an upper layer for a plurality of unicast quality of service (QOS) data frames of each traffic identifier (TID) with a block acknowledgement (BA) agreement.

15. The AP device of claim 2, wherein the group of AP MLDs comprises the current serving AP MLD and the new serving AP MLD.

16. The AP device of claim 2, wherein the AP device comprises an AP MLD compatible with an Institute of Electrical and Electronics Engineers (IEEE) 802.11 protocol.

17. An access point (AP) multi-link device (MLD) compatible with an Institute of Electrical and Electronics Engineers (IEEE) 802.11 protocol, the AP MLD comprising:
a controller configured to determine a frame exchange context for a plurality of frame exchanges with a non-AP MLD roaming from a current serving AP MLD affiliated with a roaming MLD group identifying address to a new serving AP MLD affiliated with the roaming MLD group identifying address, wherein the roaming MLD group identifying address is used to identity a group of AP MLDs for association or key negotiation with the non-AP MLD; and
a wireless transceiver configured to conduct the frame exchanges with the non-AP MLD based on the frame exchange context.

18. The AP MLD of claim 17, wherein the frame exchange context comprises information for downlink (DL) frame transmission from the new serving AP MLD to the non-AP MLD or information for uplink (UL) frame reception at the new serving AP MLD from the non-AP MLD.

19. The AP MLD of claim 17, wherein the frame exchange context comprises information regarding whether the non-AP MLD's emergency preparedness communications service (EPCS) is enabled.

20. A method for wireless communications, the method comprising:
at a group of access point (AP) multi-link devices (MLDs) identified by a roaming MLD group identifying address, determining a frame exchange context for a plurality of frame exchanges with a non-AP device roaming from a current serving AP MLD affiliated with the roaming MLD group identifying address to a new serving AP MLD affiliated with the roaming MLD group identifying address; and
conducting the frame exchanges with the non-AP device based on the frame exchange context.
